(19) United States
(12) Patent Application Publication
(10) Pub. No.: US 2020/0395744 A1
(43) Pub. Date: Dec. 17, 2020

(54) Quick Splice Tool

(71) Applicant: Carlton Evan Chase, Austin, TX (US)

(72) Inventor: Carlton Evan Chase, Austin, TX (US)

(21) Appl. No.: 16/895,656

(22) Filed: Jun. 8, 2020

Related U.S. Application Data
(60) Provisional application No. 62/860,684, filed on Jun. 12, 2019.

(51) Int. Cl. H02G 1/14; H01R 4/12

(52) U.S. Cl. CPC H02G 1/14; H01R 4/12

(57) ABSTRACT

This present patent application discloses a quick splice tool for splicing braided wire and terminating wire ends. The quick splice tool is a cylindrical shaped wire joining or terminating structure that utilizes a needle mechanism to split wire and a center, circular mechanism to hold the wire for stabilization and metal discs to prevent the wire from being pulled back out. The quick splice tool effectively prevents from having to use a wire crimper to splice and terminate wire ends, which saves extensive amounts of time and effort when splicing braided electrical wire. The quick splice tool ensures all connectors and terminated ends are reusable and capable of being reconnected within the electrical line.

### CROSS-REFERENCE TO RELATED APPLICATION

The present application claims priority to, and the benefit of, U.S. Provisional Application No. 62/860,684, which was filed on Jun. 12, 2019 and is incorporated herein by reference in its entirety.

### BACKGROUND

The present invention relates generally to the field of wire splicers. More specifically, the present invention relates to a unique design of a quick splice tool for splicing braided wires and terminating wire ends. The quick splice tool utilizes a punch, piercing device or needle mechanism to split wire and a center, circular mechanism to grasp and hold the wire for stabilization and alignment. The quick splice tool effectively avoids the need to have to use a wire crimper or other traditional tools to splice and terminate wire ends. The quick splice tool saves extensive amounts of time and effort while splicing braided electrical wires together. Further, the innovative quick splice tool ensures that all connectors and terminated ends are reusable and capable of being reconnected within an electrical line. Accordingly, the present specification makes specific reference to the present invention. However, it is to be appreciated that aspects of the present invention are also equally amenable to other like applications, devices and methods of manufacture.

Different cables are designed for different uses and purposes. Twisted pair cables and braided cables (also referred to as coaxial cables, e.g. hard line coaxial cable, radiating and triaxial cable types are also included) are both used to create a basic connection for network cabling. Coaxial cables are used for the transmission of high frequency electrical signals with low losses. Coaxial cables are used in a variety of applications including telephone trunklines, broadband internet networking cables, high speed computer data busses, carrying cable television signals, and connecting radio transmitters and receivers to their antennas. The data transmitted between computers connected to a wired network travels through network cables.

Vast variety of wires exist such as optic fiber cable, braided wires, and other electrical wires are used in day-to-day life of an individual. Any device that needs an electric connection utilizes one or another kind of an electric wire. Different cables are designed for different uses and purposes. Twisted pair cables and braided cables are used to create a basic or common connection for network cabling and for other similar purposes. A braided wire is typically a type of shielding that gets built into a cable for protecting the cable from electromagnetic interference or to increase the flex life and mechanical strength of the cable. Structurally, braided shielding includes several fine wires that are tightly woven or braided together into a meshed tubular formation that wraps around a core conductor, typically a copper wire. Overtop is a thin insulating outer layer that covers and protects the braided or woven wire and the internal components of the cable.

Such wires are often damaged by electrical overloading, mechanical failure, cable sheath degradation, excessive heating of cable, rodent attack, mechanical wear, bending fatigue breaks, corrosion damage, tensile overload breaks, shear breaks, etc., thereby causing the device connected via the cable to stop working or to have diminished performance if the cable is not completely compromised. In order to repair such faulty devices, damaged wires need to be either repaired or replaced. Further, while setting up new cables and devices, or repairing or replacing a faulty or otherwise corrupted wire, a need for splicing and terminating the wires arises.

By way of background, wire repairing or replacement is performed typically by performing, wire crimping, wire core twisting, wire capping/connecting, and wire terminating. Individuals usually repair the damaged wires by hand by stripping the wire and connecting the damaged portion using an electrical tape or other insulation tape. Although the hand repair method is cost-effective if the wires are not connected properly, poor electrical connections can reduce transmissions and may cause excessive heat, thereby damaging wire again and potentially causing damage to the connected device(s).

Further, sometimes the repairing of wires requires a user to call an electrician or other qualified individual to detect the location of an exact fault and further repair the damaged wire by using various wire repairing tools such as wire crimper, wire cutter, wire connector, wire terminator, etc. The time for repairing damaged wires in such cases depends on the availability of the electricians or professionals and the required tools. A user having knowledge of wire repairing tools may buy and keep these tools at home and use these separate tools to repair the damaged wire, and therefore repair the faulty device. This complete process of using separate tools for separate steps can be costly, time-taking and frustrating for the user.

It is noted that various wire splicing mechanisms require separate tools for each step, which makes the wire splicing process costly. Further, another method is to replace the damaged wires in order to repair the device or equipment with which the wire is utilized. Wire replacement in such situations require the complete wire to be removed and then replaced, which makes it a costly and time-consuming process. Further, in such scenarios, wire termination is required for effective operation of the connected devices and/or equipment and the wires connecting them to networks and other service providers. However, while using the conventional splicing mechanisms, the terminated wires are rendered unusable for future connections, creating waste and adding to the cost of the repair.

Additionally, braided or woven wire repair requires more time and effort and can be time-consuming and frustrating for the user, particularly if not experienced. Current wire repair solutions leave the terminated wires unusable for future connections. Conventional wire splicing mechanisms oftentimes fail to satisfy the user's wants and needs and may require the user to have multiple tools and supplies. Accordingly, there is a need for a splicing method which ensures that the terminating ends are reusable and create a serviceable connection and is cost-effective as well.

Therefore, there exists a long felt need in the art for a wire splicing tool that provides a quick and efficient solution for splicing optical fiber, braided or woven wires, and the like, which saves extensive amount of time and effort of a user. There is also a long felt need in the art for a quick splice tool that is cost-effective. There is also a long felt need in the art for a splicing method that does not requires separate devices for performing different wire splicing and terminating steps. There is also a long felt need in the art for a wire splicing mechanism which ensures that all connectors and terminated ends are reusable and capable of being reconnected within an electrical line. Additionally, there is also a long felt need in the art for a quick splice tool that holds the connected wires strongly thereby preventing providing proper electrical connection to a device. Finally, there is a long felt need in the art for a quick splice tool that is convenient and easy for individuals to use when joining or connecting wires.

The subject matter disclosed and claimed herein, in one embodiment thereof, includes an innovative quick splice tool for splicing braided or woven wires and terminating wire ends. The quick splice tool utilizes a needle, punch or piercing mechanism to split wire and a center, circular mechanism to hold the wire for stabilization during the repair. The quick splice tool effectively prevents from a user from having separate tools to crimp, splice and/or terminate wire ends. The quick splice tool saves extensive amounts of time and effort while splicing braided or woven electrical wire. Further, the innovative quick splice tool ensures that all connectors and terminated ends are reusable and capable of being reconnected within an electrical line.

In this manner, the quick splice tool of the present invention accomplishes all of the forgoing objectives, and provides a relatively quick and easy solution to splice braided or woven wires according to the wants and needs of the user. The unique quick splice tool of the present invention includes different functions such as wire crimping, wire terminating and wire splicing in a standalone product, thereby reducing costs. Finally, the quick splice tool of the present invention can be sized and configured by the user to fit a variety of gauges and sizes of wire and utilize specific feature such as crimping, splicing or terminating of the tool as per the user requirements.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises an innovative quick splice tool for splicing braided or woven wires and terminating wire ends. The quick splice tool utilizes a needle, punch or piercing mechanism to split wire and a center, circular mechanism to hold the wire for stabilization during the repair. The quick splice tool effectively prevents the user from having to use separate tools to crimp, splice and/or terminate wire ends. The quick splice tool saves extensive amounts of time and effort while splicing braided or woven electrical wire. Further, the innovative quick splice tool ensures that all connectors and terminated ends are reusable and capable of being reconnected within an electrical line in order to service the connected devices. The quick splice tool can be utilized for various types of wires such as optical fiber, cable wires, coaxial wires, braided and woven wires and the like.

The subject matter disclosed and claimed herein, in one embodiment thereof, includes a quick splice tool for splicing braided or woven wires and the like. The unique splice tool is an open ended cylindrical shaped structure which features a needle, punch or piercing mechanism and a circular center piece to stabilize and hold the wire while the repair is made. Both the ends of the cylindrical shaped structure are open so as to insert a braided or woven wire from each end, to join the wires together once the splice or impacted section has been removed. The needle is used to split the braided wire while the center circular piece is used to hold the wire in position for the repair. The splice tool includes in one embodiment four metal discs, two in each side, on the cylindrical openings. Each disc is cut or stamped to create a tapering fan shape that allows a flush-cut braided electrical wire with sheathing to slip in without being pulled back out. That is, the fan shaped disc grips the wire end to prevent the wire from being inadvertently removed from the tool which the repair is completed. The two openings structure of the splice tool is utilized for braided electrical wire splice connectors.

In a further embodiment of the present invention, the cylindrical shaped splice tool has a predetermined length and diameter. Further, the splice tool of the present invention is produced to fit a variety of gauges of wire. The splice tool of the present invention is strong and has good gripping capability to hold the wires while joining and may be constructed from any suitable materials, that maintain sufficient rigidity such as PVC, or other plastic or resin-based material. The needle, punch or piercing mechanism includes a two-sided tapered metal spike or pin to terminate the wire. The metal spike provides a joining point for the braided wires and conducts electricity without conducting heat in the wire setup.

In yet another embodiment of the present invention, a quick terminating tool for braided or woven wire is disclosed. The quick terminating tool has a generally cylindrical shaped structure with one open end to insert a braided wire to be terminated. Another end is connected with an insulated ring-shaped structure. The unique structure of the quick terminating tool enables quick and easy termination of braided wires. The insulated ring terminals are used to connect wiring to screws and studs. The rings are used to mount the wires, where electrical contact is made on the flat surface of a ring or spade terminal. Further, the insulation properties in the ring terminal provide a barrier from extreme heat and cold, and protects from dust, debris and corrosion so the wire connection can stand up to use for long periods of time.

The quick terminating tool features a needle, punch or pin mechanism and a circular center piece. The quick terminating tool includes two or more metal discs inside the cylindrical structure. Each disc is cut or stamped to create a tapering fan shape that allows a flush-cut braided electrical wire with sheathing to slip in without being pulled back out. Further, the quick terminating tool includes a tapered metal spike, needle or pin that is attached to the ring terminal, to terminate the braided wire. The metal-based spike conducts electricity without conducting heat in the wire setup.

In one exemplary embodiment, a splicing tool, is provided and includes a generally cylindrical housing that has first and second ends. The housing is formed of a generally rigid material and there is a disc disposed centrally of the housing. The housing has first and second wire retention elements, with the first wire retention element disposed on one side of the disc and the second wire retention element disposed on a side of the disc opposite from the first wire retention element. The housing also includes a wire termination element disposed centrally of the housing and between the first and second wire retention elements.

In a still further exemplary embodiment of the present invention, a splicing tool, is provided and includes a housing having first and second ends with the housing sized and configured to receive a wire in at least one of the first and second ends. A disc is disposed within the housing and the disc is shaped to fit within the housing and to hold the wire. A wire terminating element, is included and the wire terminating element is selected for a gauge of the wire inserted in the housing, and the wire terminating element connects the wire with one of a second wire or terminal.

In a yet still further exemplary embodiment of the presently described invention, a splicing tool and wire combination, is provided and includes at least one braided or woven wire and a housing sized and configured to receive the wire of a predetermined gauge. The housing having at least one open end and the housing having a disc for centering the wire within the housing. A wire termination element has a needle for insertion into the wire and the at least one retention piece having a radially extending flexible configuration for retaining the wire once inserted into the housing. The wire and termination element forming an electrical connection

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one possible embodiment of a quick splice tool for wires of the present invention in accordance with the disclosed structure;

FIG. 2 illustrates a perspective view of another possible embodiment of a quick terminating tool for wires of the present invention in accordance with the disclosed structure;

FIG. 3 illustrates a perspective view of one possible embodiment of a quick splice tool while connecting braided wires of the present invention in accordance with the disclosed structure; and

FIG. 4 illustrates a perspective view of another possible embodiment of a quick terminating tool while terminating a braided wire of the present invention in accordance with the disclosed structure.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

As noted above, there exists a long felt need in the art for a wire splicing tool that provides a quick solution for splicing braided or woven wires, optical fiber, and the like, which saves an extensive amount of time and effort of a user. There is also a long felt need in the art for a quick splice tool that is cost-effective. There is also a long felt need in the art for a splicing method that does not require multiple separate tools for performing different wire splicing steps. There is also a long felt need in the art for a wire splicing mechanism which ensures that all connectors and terminated ends are reusable and capable of being reconnected within an electrical line. Additionally, there is also a long felt need in the art for a quick splice tool that holds the connected wires strongly thereby providing proper electrical connection between spliced or connected ends and ultimately to a device. Finally, there is a long felt need in the art for a quick splice tool that is convenient and easy for individuals to use when joining or connecting wires together.

The innovative product of the present invention features a quick splice hand tool used for splicing braided or woven wires and terminating wire ends to form a new connection. The splice tool is a generally tubular structure having a cylindrical body that features a needle or punch mechanism, one or more metal disks and a circular center piece to enable functionality of the splice device. The quick splice tool can be manufactured in varying size structure to accommodate different sized wires or gauges. Further, the splice hand tool provides multiple functionalities such as wire crimping, wire connecting, wire terminating, etc. and therefore, a standalone product serves all the needs of the users and offers a quick and convenient splicing and terminating wire solution when compared with prior art methods and tools.

The present invention, in one exemplary embodiment, is a quick splice tool for splicing braided wires and the like. The unique splice tool has a generally cylindrical shaped structure with both the ends open to insert a braided or woven wire from each end, to join the wires and form a connection. The splice tool features a needle mechanism and a circular center piece. The needle is used to split the braided wire while the center circular piece is used to hold the wire in a position while the repair or splice is created. The circular central piece is placed toward the middle position of the cylindrical body and two metal discs are provided on each side of the circular center piece. Each metal disc is cut or stamped to create a tapering fan shape that allows flush-cut braided electrical wire with sheathing to slip in without being pulled back out and guard against inadvertent disconnection once the splice has been completed. The unique structure of the quick splice hand tool, strongly holds the braided wires from each open end of the tubular structure, and provides a mechanism for the electrical connection between the joined braided wires. The two-opening structure of the splice tool is utilized for braided electrical wire splice connectors.

In a further embodiment of the present invention, the cylindrical shaped splice tool is of a predetermined length and diameter. Further, the splice tool can be manufactured in various sizes to accommodate a variety of gauges and sizes of wire. The splice tool of the present invention is strong and has good gripping capability to hold the wires while joining. The needle mechanism includes a two-sided tapered metal spike or needle to terminate each of the wire. The metal spike provides a joining point for the braided wires and conducts electricity without conducting heat in the wire setup.

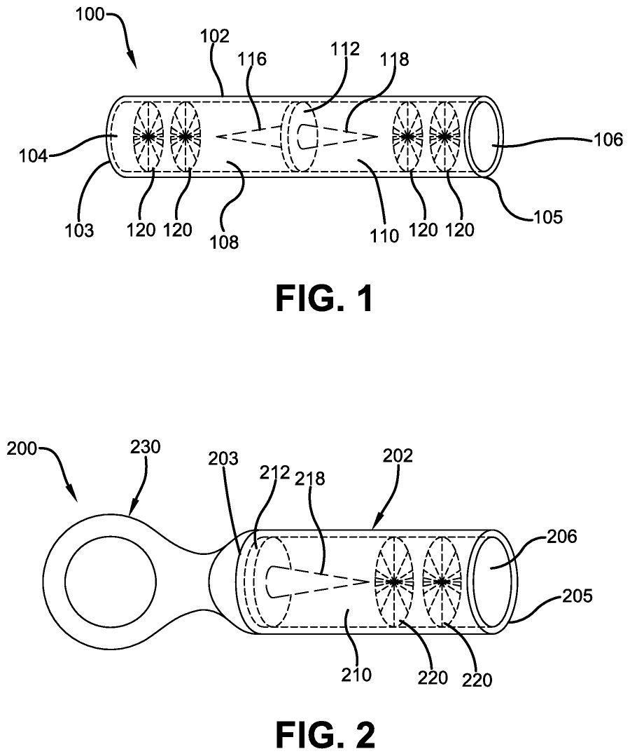

Referring initially to the drawings, FIG. 1 illustrates a perspective view of one possible embodiment of a quick splice tool for wires of the present invention in accordance with the disclosed structure. The quick splice tool 100 comprises a tubular or cylindrical structure 102 having a first end 103 and a second end 105. The first end 103 has an opening 104 and the second end 105 has an opening 106; and each of the openings 104, 106 allows braided wires to slip inside the cylindrical structure 102 of the quick splice tool 100 for joining two separate braided or woven wires for electrical connection. The cylindrical body 102 of the quick splice tool 100 can be made up of material reasonably rigid material such as plastic, stainless steel, any metal, Nylon, Copper, Polypropylene, or any material known to one of skill in the art for the manufacturing of wire splice tool 100.

More specifically, the quick splice tool 100 comprises a circular center piece 112 placed at a middle of the cylindrical structure 102 to hold the braided wire. The circular center piece 112 divides the cylindrical structure 102 into roughly two equal sized structures, a left tubular structure 108 and a right tubular structure 110. Each portion 108 and 110 comprises two metal discs 120, which is cut or stamped to create a tapering fan shape that allows flush-cut braided electrical wire with sheathing to slip in the quick splice tool 100 without being pulled back out. The diameter of the metal disc 120 is similar to the diameter of the cylindrical structure 102. Further, the quick splice tool includes a two-sided tapered metal spike or needle structure to split the braided wire. A left-side needle 116 splits a braided wire that slips inside the open end of the left tubular structure 108 and a right-side needle 118 splits another braided wire that slips inside the open end of the housing in the right tubular structure 110. The needle 118 is made up of any metal such as steel, aluminum, iron, or the like, and is sharp enough to split a core of the braided wired to be connected. The unique structure of the splice wire tool 100 crimps and connects the wire in a manner such that all connectors are reusable, without requiring separate tools for these wire splicing steps. The splice wire hand tool 100 can be used while repairing any damaged wires, or while setting up a new device or connection. Further, the splice wire tool 100 can be of various sizes to fit a variety of gauges of wire.

FIG. 2 illustrates a perspective view of another possible embodiment of a quick terminating tool for wires of the present invention in accordance with the disclosed architecture. The quick terminating tool 200 is a hand tool utilized for terminating wire ends, such that the terminated wires are rendered reusable and capable of being reconnected within the electrical line. The wire terminating tool 200 comprises a cylindrical or tubular structure 202, having an opening 206 at one end 205. The other end 203 is closed and a ring-shaped terminal or cable lug 230 is attached on the end 203. A variety of ring sizes are available and are designed to fit the requirements of amperage throughput and the wires being used. A ring 230 size can be selected based on the wire gauge and user requirements. The ring-shaped terminal 230 is typically insulated and is utilized to connect wiring to screws and studs. The rings 230 are used to mount the wires, where electrical contact is made on the flat surface of a ring or spade terminal. Using an insulated closed barrel terminal 230 is not only ideal for crimping the wire to the terminal, but this is what encapsulates the connections. The insulation properties in the ring terminal 230 provide a barrier from extreme heat and cold, and protects from dust, debris and corrosion so the wire connection can stand up to use for long periods of time. Further, different shaped terminals such as spade terminals, flanged spade tongue terminal, and other terminals known in the art can also be utilized to serve the purpose.

A tapered metal spike 218 is attached to an internal side of closed end 203, such that the spike or the needle 218 lies inside the tubular structure 202. The tubular structure 202 further includes two metal discs 220 with a diameter similar to a diameter of the tubular structure 202. Each metal disc 220 is cut or stamped to create a tapering fan shape that allows flush-cut braided electrical wire with sheathing to slip inside the wire terminating tool 200 without being pulled back out. The needle 218 is made up of any metal such as iron, or the like, and is sharp enough to split a core of the braided wired to be connected. Further, the cylindrical body 202 of the quick wire terminating tool 200 can be made up of material such as plastic, stainless steel, any metal, Nylon, Copper, Polypropylene, or any material known to one of skill in the art for the manufacturing of wire terminating tool 200.

The quick splice tool 100 and the quick terminating tool 200 of the present invention may be manufactured in a colored cylindrical body or may be transparent as well. The quick splice tool 100 and the quick terminating tool 200 are particularly good at splicing and terminating wires respectively, and ensures all connectors and terminated ends are reusable and capable of being reconnected within the electrical line. The housing may be provided with instructions for recommended use or instructions, as well as certifications such as UL, CE or other certifying bodies as may be necessary for such a device.

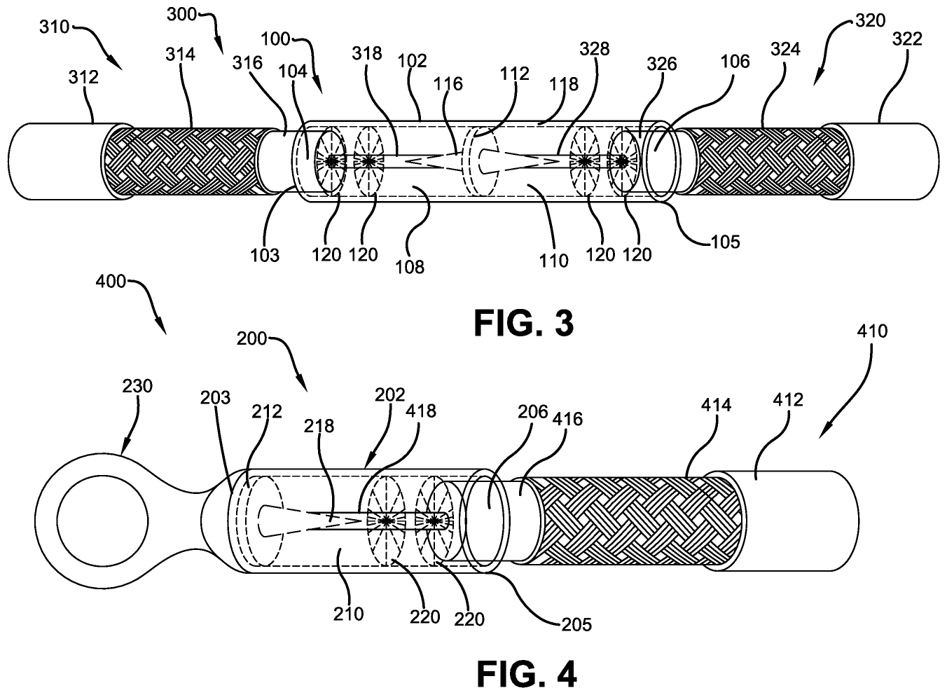

FIG. 3 depicts a further embodiment of the present invention which comprises a wire splicing assembly 300 in accordance with the disclosed architecture. The wire splicing assembly 300 comprises a quick wire splice tool 100 in which braided wires are slipped inside to join them for electrical connection. A first braided wire 310 is inserted through the first opening 104 of the first end 103 of the cylindrical structure 102 of the quick splice tool 100. The first braided wire 310 is comprised of a core center conductor 318 surrounded by a dielectric 316, which is further covered by a braided shield 314, and the outermost jacket covering 312. The first braided wire 310 is inserted in the left tubular structure 108 of the splice tool 100 such that the metal discs 120 grips the inserted wire 310 thereby preventing the first braided wire from being pulled back out. The core center conductor 318 is split by the left-side needle 116 and finally reaches the central circular piece 112, which is used to hold the wire.

Further, a second braided wire 320 is inserted through the second opening 106 of the second end 105 of the cylindrical structure 102 of the quick splice tool 100. The second braided wire 320 is comprised of a core center conductor 328 surrounded by a dielectric 326, which is further covered by a braided shield 324, and the outermost jacket covering 322. The second braided wire 320 is inserted in the right tubular structure 110 of the splice tool 100 such that the metal discs 120 grips the inserted wire 320 thereby preventing the second braided wire 320 from being pulled back out. The core center conductor 328 is split by the right-side needle 118 and finally reaches the central circular piece 112, which is used to hold the wire.

Both the braided wires 310, 320 are joined at the central circular piece 112 such that the electricity flows through the wires 310 and 320, without any obstruction. The diameter of both the braided wires 310, 320 is such that it easily slips inside the tubular structure 108, 110 and the tapering fan shaped metal discs 120 allows flush-cut braided electrical wires with sheathing to slip in without being pulled back out.

FIG. 4 illustrates a perspective view of another possible embodiment of a wire terminating assembly 400 for terminated the braided wires of the present invention in accordance with the disclosed architecture. The wire terminating assembly 400 comprises a braided wire 410 inserting in the tubular structure 210 of the wire terminating tool 200. The braided wire 410 is comprised of a core center conductor 418 surrounded by a dielectric 416, which is further covered by a braided shield 414, and the outermost jacket covering 412. The braided wire 410 is inserted in a manner such that the two metal discs 220 grips the inserted wire 410 thereby preventing the braided wire 410 from being pulled back out. The core center conductor 418 is split by the needle 218 and finally reaches the circular piece 212, which is used to hold the wire.

Further, the ring-shaped terminal 230 provides a mechanism to enable the wire 410 held at the circular piece to 212 to be terminated such that the terminated ends are reusable and are capable of being reconnected within an electrical line. A ring 230 size can be selected based on the wire size and user requirements. Further, different shaped terminals such as spade terminals, flanged spade tongue terminal, and other terminals known in the art can also be utilized to serve the purpose. Also, the wire to be spliced or to be terminated is not limited to braided wire and can be other similar structure wires such as coaxial wires, multiple strand wires, etc.

The novel wire splice tool of the present invention allows for easy portability while providing consistent, reliable electrical connections. Further, novel wire splice tool of the present invention also can be utilized by either professional or novice users. In this manner, the novel wire twister fills a need for a simple, reliable, and consistent tool for joining electrical connections. Further, the novel wire twister of the present invention provides a compact, rigid shaped tool, at an economical price that can be easily carried on the person.

It is an object of the present invention to provide a novel splice tool having no moving parts which can be utilized by electrical craftsmen to make consistent, reliable wire connections. Further, it is an object of the present invention to provide a novel splice tool which also can be utilized by unskilled craftsmen to make consistent, reliable wire connections. The quick splice tool apparatus can be easily used in standard and awkward positions of work.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “quick splice tool”, “quick splice hand tool”, “splice wire hand tool”, “splice tool” and “wire connecting tool” are interchangeable and refer to the quick splice tool 100 of the present invention. As used herein “wire terminating tool”, “quick wire terminating tool” and “quick terminating tool” are used interchangeably to describe a wire terminating tool 200 for terminating braided wire ends.

Notwithstanding the forgoing, the quick splice tool 100 and the wire terminating tool 200 of the present invention can be of any suitable size and configuration as is known in the art without affecting the overall concept of the invention, provided that it accomplishes the above stated objectives. One of ordinary skill in the art will appreciate that the size, configuration and material of the quick splice tool 100 and the wire terminating tool 200 as shown in the FIGS. are for illustrative purposes only, and that many other sizes of the quick splice tool 100 and the wire terminating tool 200 are well within the scope of the present disclosure. Although the dimensions of the quick splice tool 100 and the wire terminating tool 200 are important design parameters for user convenience, the quick splice tool 100 and the wire terminating tool 200 may be of any size that ensures optimal performance during use and/or that suits user need and/or preference.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A splicing tool, comprising;
a housing having first and second ends and the housing sized and configured to receive a wire in at least one of the first and second ends;
a disc disposed within the housing, the disc shaped to fit within the housing and to hold the wire in position;
a wire terminating element, the wire terminating element selected for a gauge of the wire inserted in the housing, the wire terminating element for connecting the wire with one of a second wire or terminal.

2. A splicing tool as recited in claim 1, wherein the housing is generally cylindrically shaped and is formed of a rigid material.

3. A splicing tool as recited in claim 1, wherein the wire terminating tool is one of a needle, punch or pin.

4. A splicing tool as recited in claim 1, wherein the disc is a circular ring.

5. A splicing tool as recited in claim 1, further including at least one retention piece, the at least one retention piece having a tapered shape to grasp the wire after insertion and to prevent removal.

6. A splicing tool as recited in claim 5, wherein the splicing tool is provided with first and second retention pieces.

7. A splicing tool as recited in claim 6, wherein each of the first and second retention pieces has a fan shape extending radially outward from a central portion.

8. A splicing tool as recited in claim 1, wherein the first end of the housing is open and the second end of the housing is the terminal.

9. A splicing tool and wire combination, comprising;
at least one braided or woven wire;
a splicing tool, the splicing tool having a housing sized and configured to receive the wire of a predetermined gauge, the housing having at least one open end;
the housing having a disc for centering the wire within the housing;
a wire termination element having a needle for insertion into the wire;
at least one retention piece having a radially extending flexible configuration for retaining the wire once inserted into the housing; and
the wire and termination element forming an electrical connection.

10. A splicing tool and wire combination as recited in claim 9, wherein the housing has first and second open ends.

11. A splicing tool and wire combination as recited in claim 10, wherein a second braided wired is inserted into one of the first and second ends opposite the at least one braided wire.

12. A splicing tool and wire combination as recited in claim 11, wherein first and second wire retention pieces are provided and the first wire retention piece secures the at least one braided wire and the second wire retention piece secures the second braided wire.

13. A splicing tool and wire combination as recited in claim 11, wherein the wire termination element is inserted into each of the first and second braided wires.

14. A splicing tool and wire combination as recited in claim 13, wherein the wire termination element has first and second ends, with the first end inserted into the at least one braided wire and the second end inserted into the second braided wire.

15. A splicing tool, comprising;
a generally cylindrical housing having first and second ends, the housing formed of a generally rigid material;
a disc disposed centrally of the housing;
a first and second wire retention elements, with the first wire retention element disposed on one side of the disc and the second wire retention element disposed on a side of the disc opposite from the first wire retention element; and
a wire termination element disposed centrally of the housing and between the first and second wire retention elements.

16. A splicing tool as recited in claim 15, wherein the wire termination element has first and second ends.

17. A splicing tool as recited in claim 15, further comprising a first wire inserted in the first end of the housing and a second wire inserted in the second end of the housing.

18. A splicing tool as recited in claim 17, wherein each of the wire retention elements is flexible and has a radially extending pattern to hold the first and second wires in position within the housing.

19. A splicing tool as recited in claim 18, wherein the wire termination element connects to each of the first and second wires to form a connection.

20. A splicing tool as recited in claim 19, wherein the wire termination element has first and second ends.
